(19) United States
(12) Patent Application Publication
(10) Pub. No.: US 2017/0289079 A1
(43) Pub. Date: Oct. 5, 2017

(54) SYSTEMS, METHODS, AND DEVICES FOR ADJUSTING CONTENT OF COMMUNICATION BETWEEN DEVICES FOR CONCEALING THE CONTENT FROM OTHERS

(71) Applicant: Lenovo Enterprise Solutions (Singapore) Pte. Ltd., New Tech Park (SG)

(72) Inventors: Gary David Cudak, Wake Forest, NC (US); Shareef Fathi Alshinnawi, Apex, NC (US); Jeffrey Scott Holland, Newton, NC (US); Pradeep Ramineni, Cary, NC (US)

(21) Appl. No.: 15/086,171

(22) Filed: Mar. 31, 2016

(51) Int. Cl. H04L 12/58; H04L 29/08

(52) U.S. Cl. CPC H04L 51/063; H04L 67/306; H04L 51/04

(57) ABSTRACT

Systems, methods, and devices for adjusting content of communication between devices for concealing the content from others are disclosed. According to an aspect, a method may be implemented at a communications device including a user interface, a processor, and memory. The method includes receiving a communication for presentation on the communications device. Further, the method includes identifying at least one person located in proximity to the communications device. The method also includes determining a profile of a current user of the communications device. Further, the method includes adjusting content of the communication based on a comparison of a profile of the identified at least one person and the determined profile. The method also includes using the user interface to present the adjusted content to the current user.

### TECHNICAL FIELD

The presently disclosed subject matter relates to systems, methods, and devices for adjusting content of communication between devices for concealing the content from others.

### BACKGROUND

The use of computing devices by people to communicate with each other is very pervasive. Example computing devices used to communicate content include smartphones, computer tablets, laptop computers, and the like. Usually communication content, such as text and images, is displayed on a display of the computing device. For example, a received email or text message can be selected, opened, and displayed via a display of a recipient computing device.

A problem with displaying content on a display is that it may be intended to be confidential and others may be nearby in a position to view the displayed content. A previous effort to conceal the content include blurring the displayed content. However, such a change may make it also difficult for the intended recipient to read or otherwise understand the content.

In view of the foregoing, there is a need for improved techniques to change received content such that it is difficult for surrounding people to understand but still understandable by the intended recipient.

### SUMMARY

Disclosed herein are systems, methods, and devices for adjusting content of communication between devices for concealing the content from others. According to an aspect, a method may be implemented at a communications device including a user interface, a processor, and memory. The method includes receiving a communication for presentation on the communications device. Further, the method includes identifying at least one person located in proximity to the communications device. The method also includes determining a profile of a current user of the communications device. Further, the method includes adjusting content of the communication based on a comparison of a profile of the identified at least one person and the determined profile. The method also includes using the user interface to present the adjusted content to the current user.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 illustrates a block diagram of an example system for adjusting content of communication between devices for concealing the content from others in accordance with embodiments of the present disclosure;

FIG. 2 is a flow chart of an example method for adjusting content of communication between devices for concealing the content from others in accordance with embodiments of the present disclosure; and

FIGS. 3A and 3B illustrate screen displays showing example text input on one computing device and the adjusted text presented on another computing device, respectively, in accordance with embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the computing device and achieve the stated purpose of the computing device.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, a user interface can be a display window or display object, which is selectable by a user of a mobile device for interaction. The display object can be displayed on a display screen of a mobile device and can be selected by, and interacted with by, a user using the user interface. In an example, the display of the mobile device can be a touch screen, which can display the display icon. The user can depress the area of the display screen at which the display icon is displayed for selecting the display icon. In another example, the user can use any other suitable user interface of a mobile device, such as a keypad, to select the display icon or display object. For example, the user can use a track ball or arrow keys for moving a cursor to highlight and select the display object.

As used herein, the term “memory” is generally a storage device of a computing device. Examples include, but are not limited to, ROM and RAM.

Operating environments in which embodiments of the presently disclosed subject matter may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or the proposed 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the presently disclosed subject matter may be implemented in other and next-generation mobile networks and devices as well. The mobile device is the physical equipment used by the end user, typically a subscriber to the wireless network. Typically, a mobile device is a 2.5G-compliant device or 3G-compliant device (or the proposed 4G-compliant device) that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

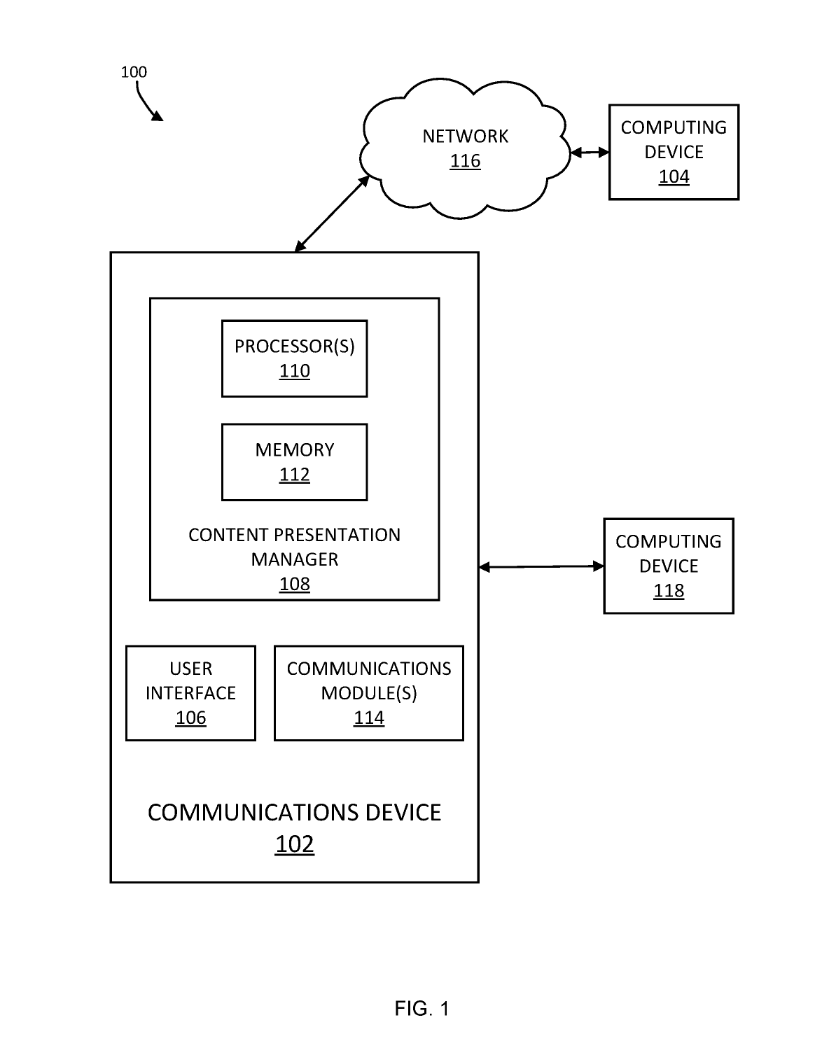

The presently disclosed subject matter is now described in more detail. For example, FIG. 1 illustrates a block diagram of an example system 100 for adjusting content of communication between devices for concealing the content from others in accordance with embodiments of the present disclosure. Referring to FIG. 1, the system 100 includes a communications device 102 configured to implement functionality for adjusting content of communication as described herein. Particularly, the communications device 102 may be a suitable computing device such as a smartphone, tablet computer, or other mobile computing device operable to receive communications from another computing device, such as computing device 104. For example, the communications device 102 may receive from another computing device an email, text message, or any other suitable communication that may be presented via a user interface 106. For example, the communications device 102 may present to a user of the communications device 102 the text of a received email or text message.

The communications device 102 includes a content presentation manager 108. The manager 108 may include suitable hardware, software, firmware, or combinations thereof for implementing the functionality described herein. For example, the manager 108 may include one or more processor 110 and memory 112 for storing instruction for implementation on the processor 110.

The content presentation manager 108 is configured to receive a communication for presentation on the communications device 102. For example, the communications device 102 may include one or more communications modules 114 configured to receive communications from another computing device such as computing device 104 via a network 116, such as the Internet and/or a mobile communications network (e.g., a cellular network). The communications module 102 may be configured to receive communications via a network or via direct wireless or wire communication from another computing device. The communications device 102 may store the received communication in memory 112.

The content presentation manager 108 is also configured to identify one or more persons located in proximity to the communications device 102, determine a profile of a current user of the communications device 102, and adjust content of the communication based on the identified person(s). For example, the manager 108 may determine that another computing device 118 is in proximity to the communications device 102 via a suitable technique. The text of the communication is in English. The manager 108 may store a profile of the current user that specifies that the current user knows a language different than English. In response to determining that the other computing device 118 is in close proximity (e.g., a few feet) to the communications device 102 and that the current user knows a different language, the manager 108 may subsequently suitably convert the text to the other language. Subsequently, the manager 108 may operate or otherwise use the user interface 108 to present the text in the other language to the current user of the communications device 108. In this way, the communication is adjusted to a different form known by the user based on his or her profile. This different language may likely be unknown to the nearby user of computing device 118 so that it is unlikely the nearby user can read the presented adjusted text.

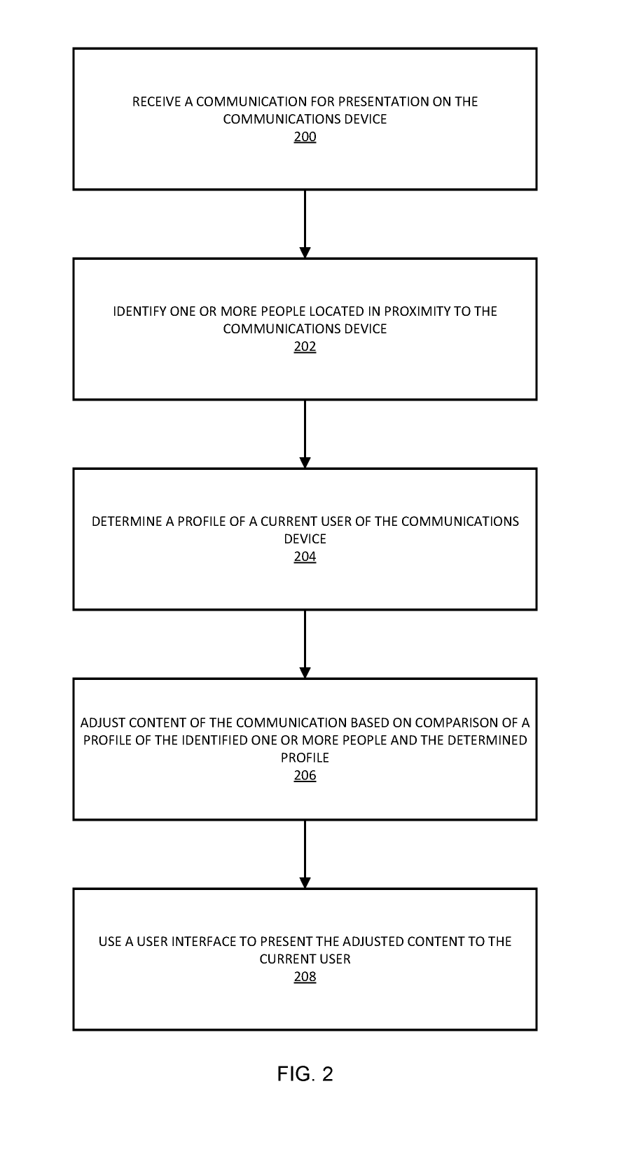

FIG. 2 illustrates a flow chart of an example method for adjusting content of communication between devices for concealing the content from others in accordance with embodiments of the present disclosure. In this example, the method is described as being implemented by the communications device 108 shown in FIG. 1, but it should be understood that the method may alternatively be implemented by any suitable computing device.

Referring to FIG. 2, the method includes receiving 200 a communication for presentation on the communications device. Now turning to the example of FIG. 1, the content presentation manager 108 of the communications device 102 may manage the receipt of an email, a text message, or any other suitable content for presentation to the user of the communications device 102. The communicated content may be, for example, a word processing document or any other readable content. The communication may be stored in memory 112 or any other suitable storage medium. The receipt of a communication from another computing device may initiate one or more of the steps of FIG. 2 subsequent to step 200. Alternatively, one or more of the steps following steps 200 of FIG. 2 may be implemented at some point in time prior to the content being selected for presentation to the user via the user interface 106. For example, a user may interact with the user interface 106 to display the content of a text message or an email, and this interaction may trigger the execution of step 202 and the subsequent steps.

The method of FIG. 2 includes identifying 202 one or more people located in proximity to the communications device. Continuing the aforementioned example, the manager 108 of FIG. 1 may suitable identify or recognize that one or more people are located in proximity to the communications device 102. For example, the communications device 102 may suitable identify a nearby computing device, such as computing device 118, via a wireless communication with the nearby computing device. The manager 108 may receive information indicating the presence of the other computing device 118 based on the wireless communication. In this way, the manager 108 can deduce that another person is nearby. Example wireless communication techniques include, but are not limited to, near field communication (NFC) and BLUETOOTH′ communication.

In another example, the manager 108 may receive information indicative of another person or the person's computing device being in proximity due to information received via the network 116. For example, the communications device 102 may implemented an application configured to receive information about a location of the other computing device. The location may be compared to a current location of the communications device 102 to determine whether the other computing device is nearby. Example applications that may indicate the location of another computing device include, but are not limited to, a social networking application or some other type of device tracking application. Information about the proximity of other computing devices and/or people may be suitably stored in the memory 112. As will be described in more detail, profile information about the other people in close proximity may be stored along with the location information.

As used herein, the term “proximity” may refer to a distance between and/or orientation of a user's computing device and another computing device or person that may be deemed sufficient such that the other person can view or otherwise perceive content presented via a user interface of the user's computing device. Example distances include, but are not limited to, between about 5 and about 20 feet. Another example distance range is between about 1 and 6 about feet. A determined distance to another device proximate the user's computing device may initiate a method in accordance with embodiments of the present disclosure.

The method of FIG. 2 includes determining 204 a profile of a current user of the communications device. Continuing the aforementioned example, the manager 108 of the communications device 102 of FIG. 1 may maintain in the memory 112 a profile a current user of the communications device 102. In an example, the profile may be entered by the user. In another example, the manager 108 may deduce a profile of a user by observing interaction of the user with the computing device 102. A profile may specify, for example, a language preference, a slang understood by the user, a reading comprehension level of the user, or the like. The manager 108 may determine the profile of the current user by identifying the current user (e.g., by receiving login information or the like for the user) and accessing the profile based on the identification.

The method of FIG. 2 includes adjusting 206 content of the communication based on a comparison of a profile of the identified people and the determined profile. Continuing the aforementioned example, the manager 108 may analyze all or various portions of the content of the communication. For example, the manager 108 may individually analyze words and phrases in the communication to determine the portions that may be changed based on the identified one or more people and the determined profile of the current user. The manager 108 may subsequently change the words or phrases (i.e., text of the content) in response to determining a replacement suitable for the current user. In this way, the text may be readable only to the current user and not other people identified as being proximate to the communications device 102. A comparison may be made of a profile of the other person and the user of the communications device 102. The profile of the other person may merely be information that the person is in proximity or more detailed profile information as described by the examples provided herein. The change to the content of the communication may be where the profiles interest the least.

The method of FIG. 2 includes using 208 a user interface to present the adjusted content to the current user. Continuing the aforementioned example, the manager 108 may control the user interface 106 to present the adjusted content to the current user. For example, the user interface 106 may be a display that is controlled to display the changed text. The changed text is understandable to the current user, but likely not understandable by surrounding people.

In accordance with embodiments, text received by the content presentation manager may be written in one human language, such as English. The content presentation manager may access a profile for the current user to determine alternatives for displaying the text. The profile may specify that Spanish or another language is readable by the current user. In response to determining that Spanish is readable by the current user, the content presentation manager may translate the received text to Spanish. Other people proximate the communications device of the current user may not be capable of reading Spanish. Thus, they would be thwarted from understanding the presented communication. In a further example, the content presentation manager may determine whether the other people in proximity can read the other language. In this example, if it is determined that they can read the other language, then the content presentation manager may select a different technique to adjust the content for presentation in accordance with other examples described herein.

In accordance with embodiments, the content presentation manager may change only one or more portions of the received text to replace the portion(s) with an equivalent representation of the portion(s). The changed text may subsequently be presented to the user via a user interface. For example, a word or phrase may be replaced to some equivalent word or phrase that can be understood by the user and likely not understood by others. In an example, a word or phrase may be replaced with its translation or an image (e.g., an emoticon) representative of the word or phrase. In another example, the word or phrase may be replaced with a word or phrase at a higher reading comprehension level such that it may not be easily understood by others. In yet another example, the word or phrase may be replaced with equivalent slang that is understood by the current user. A reading comprehension level, slang, an image, or the like understood by the user may be specified by the user's profile.

In an example of replacing a word or phrase, an acronym known to the user may be used to replace the equivalent word or phrase.

In another example of replacing a word or phrase, a user profile may specify that the user is from a particular region. Particular, words or phrases may be known only to that particular region. In this case, the content presentation manager may use the word or phrase to replace equivalent words or phrases in received text.

In another example, other profile information may be used for determining suitable replacements. For example, the following information may be considered: hobby or interests, and words or phrases commonly used by the user in other communications.

In accordance with embodiments, language to use may be scaled by the number or percentage of unauthorized people in the area.

In accordance with embodiments, a profile of a user may specify one or more of a demographic of the user, an interest of the user, a language of the user, a preference of the user, or the like. This information may be used to determine suitable techniques to change content of a received communication that may be understood by the user. The content presentation manager may apply this information to one or more portions of the content to determine how the portion(s) may alternatively be represented. The content presentation manager may subsequently change the portion(s) in accordance with the alternative representation and present the adjusted content to the user via the user interface.

In accordance with embodiments, a profile of the user of the communications device may be compared to determined profiles of others in proximity to the communications device of the user. The content presentation manager may determine a difference between the profile of the user and the others. Subsequently, the content presentation manager may adjust content of a communication received by the user's communications device based on the determined difference. For example, the profile of the user may indicate that that an alternative representation of the content is understood by the user but not by the others. In this example, the content presentation manager may change the content to the alternative representation. Conversely, the content presentation manager may not change the content in response to determining that the content is understood by the user but not likely understood by the others. This determination may be made based on an analysis of the profile of the user and the profiles of the others.

In accordance with embodiments, a user's profile may specify a text consumption rate of a user or some other measure of how fast the user can read. The content presentation manager can control the presentation of received text based on the measure. For example, the content presentation manager can control a display to only display the received text for a limited amount of time (e.g., 3 seconds) in response to determining that it would require that amount of time for the user to read the text. Thus, the text would only be displayed for the time estimated needed for the user to read the text.

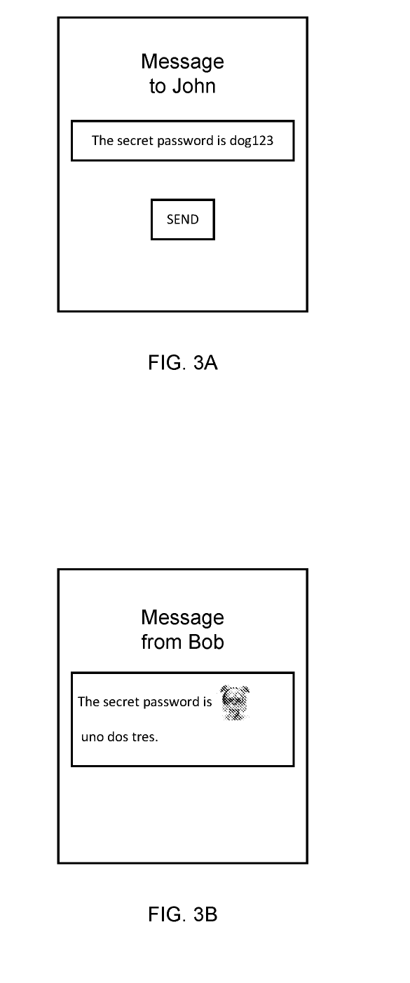

FIGS. 3A and 3B illustrate screen displays showing example text input on one computing device and the adjusted text presented on another computing device, respectively, in accordance with embodiments of the present disclosure. Referring to FIG. 3A, the screen display shows the message “The secret password is dog 123”. The message is intended for John at a different computing device, and it can be sent by selecting the displayed “SEND” button.

The screen shown in FIG. 3B is John's. This screen shows the message received from Bob as it is adjusted in accordance with embodiments of the present disclosure. In this example, the portion “dog” was replaced with a dog emoticon. The number “123” is replaced with the Spanish equivalent words for the number “1,” the number “2,” and the number “3”. In this way, it can be more difficult to a nearby person who sees the adjusted text to determine the actual sent message.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a communications device comprising a user interface, a processor, and memory:
receiving a communication for presentation on the communications device;
identifying at least one person located in proximity to the communications device;
determining a profile of a current user of the communications device;
adjusting content of the communication based on a comparison of a profile of the identified at least one person and the determined profile; and
using the user interface to present the adjusted content to the current user.

2. The method of claim 1, wherein receiving a communication comprises receiving one of an email and text message.

3. The method of claim 1, further comprising:
communicating with at least one computing device associated with the at least one person; and
determining proximity between the communications device and the at least one computing device based on the communication with the at least one computing device,
wherein adjusting content of the communication based on the determined proximity.

4. The method of claim 1, wherein communicating with at least one computing device comprises wirelessly communicating with the computing device.

5. The method of claim 1, wherein the communication comprises text,
wherein adjusting content of the communication comprises changing the text, and
wherein using the user interface comprises using the user interface to present the displayed text.

6. The method of claim 1, wherein the communication comprises text in a first human language,
wherein adjusting content of the communication comprises translating the text in the first human language to text in a second human language, and
wherein using the user interface comprises using the user interface to present the text in the second human language.

7. The method of claim 1, wherein the communication comprises text,
wherein adjusting content of the communication comprises changing the text to replace at least one portion of the text with an equivalent representation of the at least one portion, and
wherein using the user interface comprises using the user interface to present the changed text.

8. The method of claim 7, wherein the profile of the current user identifies one of a slang and reading comprehension level understood by the current user, and
wherein the equivalent representation is in accordance with the one of the slang and read comprehension level understood by the current user.

9. The method of claim 1, wherein the communication comprises text,
wherein adjusting content of the communication comprises changing the text to replace at least one portion of the text with an image, and
wherein using the user interface comprises using the user interface to present the changed text.

10. The method of claim 9, wherein the image is an emoticon.

11. The method of claim 1, wherein the profile of the current user specifies one of a demographic of the current user, an interest of the current user, a language of the current user, and a preference of the current user.

12. The method of claim 1, further comprising:
determining a profile of the identified at least one person; and
determining a difference between the profile of the current user and the profile of the identified at least one person, and
adjusting content of the communication comprises adjusting content of the communication based on the determined difference.

13. A communications device comprising:
a content presentation manager comprising a processor and memory configured to:
receive a communication for presentation on the communications device;
identify at least one person located in proximity to the communications device;
determine a profile of a current user of the communications device;
adjust content of the communication based on a comparison of a profile of the identified at least one person and the determined profile; and
a user interface configured to present the adjusted content to the current user.
